(19) United States
(12) Patent Application Publication
(10) Pub. No.: US 2026/0176910 A1
(43) Pub. Date: Jun. 25, 2026

(54) DOOR CONTROL APPARATUS, VEHICLE CONTROL SYSTEM, DOOR CONTROL METHOD, AND NON-TRANSITORY COMPUTER READABLE MEDIUM

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/423,397

(22) Filed: Dec. 17, 2025

(30) Foreign Application Priority Data
Dec. 19, 2024 (JP) 2024-224445

(51) Int. Cl. E05F 15/73

(52) U.S. Cl. CPC E05F 15/73; E05F 2015/767; E05Y 2900/506; E05Y 2900/531

(57) ABSTRACT

A door control apparatus includes a controller that controls the opening and closing of a door provided at an opening of a vehicle, based on imaging data of a predetermined imaging range of an external area relative to the opening. The controller executes a process to extract a target of motion as at least one mobile object moving toward the opening by detecting the motion from the imaging data in a time series in a predetermined area included in the imaging range, and a process to vary the opening and closing timing of the door based on the extracted at least one mobile object. In first and second areas contained in the predetermined area, the controller extracts the target as the mobile object when the direction of the motion is included within predetermined first and second ranges, respectively.

### CROSS-REFERENCE TO RELATED APPLICATION

This application claims priority to Japanese Patent Application No. 2024-224445 filed on Dec. 19, 2024, the entire contents of which are incorporated herein by reference.

### TECHNICAL FIELD

The present disclosure relates to a door control apparatus for a vehicle, a vehicle control system, a door control method for a vehicle, and a door control program.

### BACKGROUND

Patent Literature (PTL) 1 describes a boarding detection system for an elevator that estimates the presence or absence of a user's intention to board based on a time-series change in the user's position and the speed of the user's movement toward a door, and controls the opening and closing operation of the door based on the estimation result.

### CITATION LIST

### Patent Literature

PTL 1: JP 2017-124899 A

### SUMMARY

It is conceivable to estimate the presence or absence of a person's intention to board who is present on a road facing a vehicle's door to control the opening and closing operation of the vehicle's door. However, even when the person on the road is moving toward the vehicle, it does not necessarily mean that the person is approaching to board the vehicle, but it is also possible that the person is passing by the vehicle. Therefore, in contrast to determining the presence or absence of a person's intention to board an elevator in front of the elevator, it is difficult to determine the presence or absence of the person's intention to board the vehicle when the person is moving toward the vehicle. It is required to control the opening and closing operation of the door appropriately.

It would be helpful to control the opening and closing of a vehicle's door more appropriately.

A door control apparatus according to an embodiment of the present disclosure includes:
a controller configured to control the opening and closing of a door provided at an opening of a vehicle, based on imaging data of a predetermined imaging range of an external area relative to the opening,
wherein
the controller is configured to execute:
   a process to extract a target of motion as at least one mobile object moving toward the opening by detecting the motion from the imaging data in a time series in a predetermined area included in the imaging range; and
   a process to vary the opening and closing timing of the door based on the extracted at least one mobile object,
the controller is configured to:
   in a first area contained in the predetermined area, extract the target as the mobile object when the direction of the motion is included within a predetermined first range; and
   in a second area contained in the predetermined area, extract the target as the mobile object when the direction of the motion is included within a predetermined second range.

A vehicle control system according to an embodiment of the present disclosure includes:
the door control apparatus;
the vehicle; and
an imager configured to capture the imaging range.

A door control method according to an embodiment of the present disclosure is a door control method for controlling the opening and closing of a door provided at an opening of a vehicle, based on imaging data of a predetermined imaging range of an external area relative to the opening, the door control method including:
extracting, by a controller, a target of motion as at least one mobile object moving toward the opening by detecting the motion from the imaging data in a time series in a predetermined area included in the imaging range; and
varying, by the controller, the opening and closing timing of the door based on the extracted at least one mobile object,
wherein the controller is configured to:
   in a first area contained in the predetermined area, extract the target as the mobile object when the direction of the motion is included within a predetermined first range; and
   in a second area contained in the predetermined area, extract the target as the mobile object when the direction of the motion is included within a predetermined second range.

A door control program according to an embodiment of the present disclosure is a door control program configured to control the opening and closing of a door provided at an opening of a vehicle, based on imaging data of a predetermined imaging range of an external area relative to the opening, the door control program configured to cause a processor to execute operations, the operations including:
extracting a target of motion as at least one mobile object moving toward the opening by detecting the motion from the imaging data in a time series in a predetermined area included in the imaging range; and
varying the opening and closing timing of the door based on the extracted at least one mobile object,
wherein
in a first area contained in the predetermined area, the target is extracted as the mobile object when the direction of the motion is included within a predetermined first range, and
in a second area contained in the predetermined area, the target is extracted as the mobile object when the direction of the motion is included within a predetermined second range.

According to an embodiment of the present disclosure, it is possible to control the opening and closing of a vehicle's door more appropriately.

### BRIEF DESCRIPTION OF THE DRAWINGS

In the accompanying drawings:

FIG. 1 is a schematic diagram illustrating an example of a configuration of a vehicle equipped with a door to be controlled in a present disclosure;

FIG. 2 is a block diagram illustrating an example of a configuration of a vehicle control system according to the present disclosure;

FIG. 3 is a diagram illustrating an example of an image captured by a camera;

FIG. 4 is a schematic diagram explaining the determination of moving object blocks;

FIG. 5 is a side view illustrating an example of an imaging range in which people are present;

FIG. 6 is a schematic diagram illustrating a captured image corresponding to FIG. 5;

FIG. 7 is a flowchart illustrating an example procedure of a door control method according to the present disclosure;

FIG. 8 is a flowchart illustrating an example procedure of a conversion process in FIG. 7;

FIG. 9A is a diagram illustrating an example of a predetermined area divided into multiple sub-areas;

FIG. 9B is a diagram illustrating an example of the range of motion vectors;

FIG. 9C is a diagram illustrating the example of the range of motion vectors;

FIG. 10 is a diagram illustrating an example of the predetermined area divided into multiple sub-areas;

FIG. 11A is a diagram illustrating an example of the range of motion vectors;

FIG. 11B is a diagram illustrating the example of the range of motion vectors;

FIG. 12 is a diagram illustrating an example of ranges of motion vectors; and

FIG. 13 is a diagram illustrating an example of the predetermined area divided into multiple sub-areas.

### DETAILED DESCRIPTION

An embodiment of the present disclosure will be described below, with reference to the drawings. In the drawings, portions having the same configuration or function are denoted by the same reference numeral. In the description of the present embodiment, duplicate descriptions of the same portions are in some cases omitted or simplified, as appropriate.

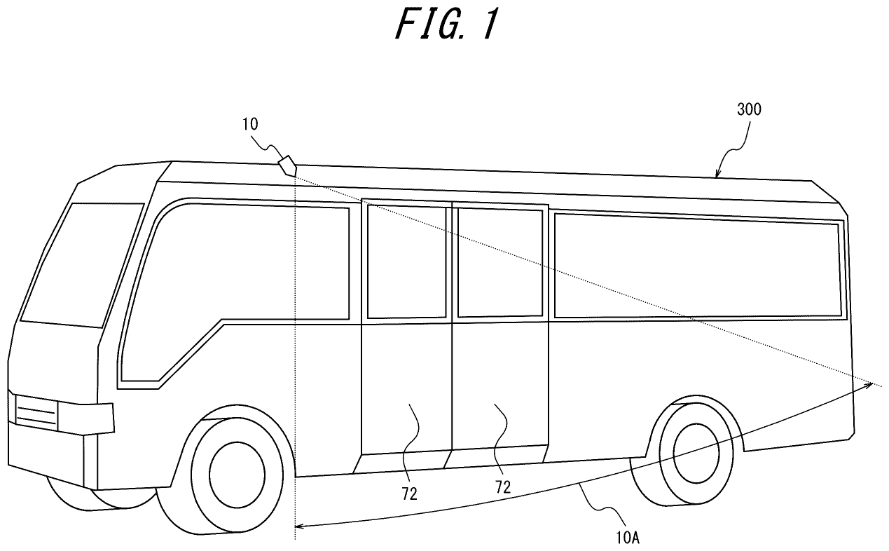

FIG. 1 is a schematic diagram illustrating an example of a configuration of a vehicle 300 equipped with a door 72 to be controlled in the present disclosure. As illustrated in FIG. 1, the vehicle 300 is equipped with the door 72 at an opening. Passengers of the vehicle 300 board the vehicle 300 through the door 72 from the outside of the vehicle 300. The door 72 may be replaced with various other configurations that can be opened and closed.

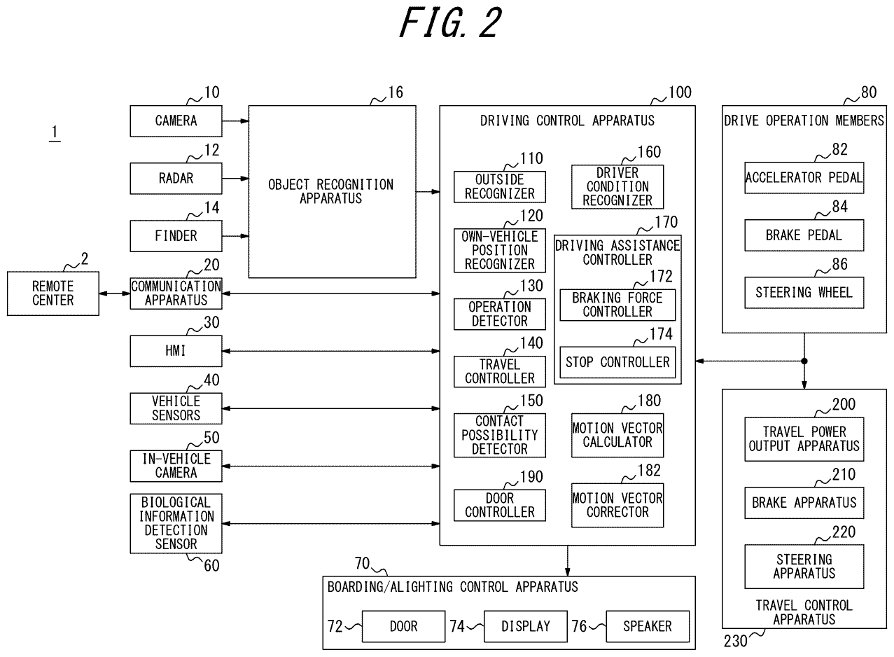

A vehicle control system 1 (see FIG. 2) captures an external area around the door 72 of the vehicle 300 using a camera 10 as an imager. The vehicle control system 1 equipped with a wide-angle bird's-eye view camera as the camera 10 can acquire captured images of a wide imaging range 10A while keeping the imaging direction of the camera 10 fixed. The vehicle control system 1 detects passengers present within the imaging range 10A as mobile objects based on the captured images, and controls the opening and closing of the door 72 based on the presence or absence of the passengers.

The passengers may rush into the vehicle 300. Around the vehicle 300, there are not only passengers who intend to rush into the vehicle 300 but also other people such as pedestrians who are not passengers. To enhance the accuracy of detecting rushing into the vehicle 300, in other words, to reduce false detections of rushing, it is necessary to determine as appropriate whether people intend to board the vehicle 300.

The vehicle control system 1 determines, from time-series data of captured images, whether a detected mobile object is a person intending to board, based on the positional relationship between the direction of movement of a predetermined area containing the mobile object and the opening such as the door 72 of the vehicle 300. Specifically, the vehicle control system 1 determines that the mobile object is a passenger intending to board the vehicle 300 when the direction of movement of the predetermined area containing the mobile object is within a certain range. The range for the direction of movement may be determined, for example, based on the positional relationship with the opening of the vehicle 300.

The vehicle control system 1 determines whether the mobile object is a passenger intending to board, based on a directional range that differs according to the positional relationship between the predetermined area and the door 72 of the vehicle 300. Therefore, even when the captured images has distortion due to the camera 10 being a bird's-eye view camera, the vehicle control system 1 can determine the boarding intention of the mobile object. Thus, according to the vehicle control system 1, it is possible to accurately determine the boarding intention of the mobile object and control the opening and closing of the door 72 of the vehicle 300 more appropriately.

Hereinafter, an example of the embodiment of the vehicle control system 1 according to the present disclosure will be described.

### (Example of Configuration of Vehicle Control System 1)

FIG. 2 is a block diagram illustrating an example of a configuration of the vehicle control system 1 according to the present disclosure. As illustrated in FIG. 2, the vehicle control system 1 according to the present disclosure includes a driving control apparatus 100 and an object recognition apparatus 16.

### <Driving Control Apparatus 100>

The driving control apparatus 100 includes an outside recognizer 110, an own-vehicle position recognizer 120, an operation detector 130, a travel controller 140, a contact possibility detector 150, a driver condition recognizer 160, a driving assistance controller 170, a motion vector calculator 180, a motion vector corrector 182, and a door controller 190.

The outside recognizer 110 recognizes the outside of the vehicle 300 based on the recognition result of the object recognition apparatus 16, which will be described later. The own-vehicle position recognizer 120 recognizes the position of the vehicle 300 based on satellite positioning data and the like. The operation detector 130 detects driving operations of the vehicle 300. The travel controller 140 controls the traveling of the vehicle 300. The travel controller 140 may control the vehicle 300 to travel by automated driving. The contact possibility detector 150 determines, based on information from the camera 10 and the like, the possibility of the vehicle 300 coming into contact with surrounding objects. The driver condition recognizer 160 recognizes the conditions of a driver of the vehicle 300 based on data detected by an in-vehicle camera 50 or a biological information detection sensor 60, which will be described later.

The driving assistance controller 170 assists the driving of the vehicle 300 based on the state of the vehicle 300 or the recognition result of the conditions of the driver of the vehicle 300. The driving assistance controller 170 includes a braking force controller 172 and a stop controller 174. The braking force controller 172 automatically brakes the vehicle 300 as needed. The stop controller 174 automatically stops the traveling of the vehicle 300 as needed.

The motion vector calculator 180 calculates a motion vector representing the direction of movement of a mobile object detected around the vehicle 300. The motion vector corrector 182 corrects the motion vector. The door controller 190 controls the opening and closing of the door 72 of the vehicle 300.

The driving control apparatus 100 may be configured with one or more processors or dedicated circuits to realize the functions of each component. In the present embodiment, the processors are general purpose processors or dedicated processors specialized for specific processing, but are not limited to these. The dedicated circuits may include, for example, field-programmable gate arrays (FPGAs) or application specific integrated circuits (ASICs).

The driving control apparatus 100 may be configured with a memory. The memory may be configured with, for example, a semiconductor memory, a magnetic memory, an optical memory, or the like, but is not limited to these. The memory may function as, for example, a main memory, an auxiliary memory, or a cache memory. The memory may be configured with an electromagnetic storage medium, such as a magnetic disk. The memory may be configured with a non-transitory computer readable medium. The memory stores any information or program to be used for operations of the driving control apparatus 100. The memory may store, for example, a system program, an application program, or the like. The memory may be included in a processor, a dedicated circuit, or the like.

The driving control apparatus 100 may be configured with an interface that communicates information, data, or the like with other components of the vehicle control system 1 or external apparatuses.

The interface may include a communication module configured to be communicable with other components or external apparatuses via a network.

The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface may be configured to be connectable to a communication module.

The interface may be equipped with terminals that correspond to a standard such as RS-232C or RS-485 so as to be directly connected to other components or external apparatuses.

The driving control apparatus 100 may be configured with an input device for accepting input of information, data, or the like from a user of the vehicle control system 1. The input device may be configured with, for example, a touch panel, a touch sensor, or a pointing device such as a mouse. The input device may be configured with a physical key. The input device may be configured with an audio input device, such as a microphone. The driving control apparatus 100 may be configured to be connectable to an external input device. The driving control apparatus 100 may be configured to be able to acquire, from the external input device, information or data inputted to the external input device.

The driving control apparatus 100 may be configured with an output device that outputs information or data to the user. The output device may include, for example, a display device that outputs visual information, such as images, or letters or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with light emitting devices, such as Light Emitting Diodes (LEDs) or Laser Diodes (LDs). The display device may be configured with various other devices. The output device may include, for example, an audio output device, such as a speaker, that outputs audio information e.g. voice. The output device is not limited to the above examples and may include various other devices. The driving control apparatus 100 may be configured to be connectable to an external output device. The driving control apparatus 100 may be configured to be able to output information or data to the external output device.

The driving control apparatus 100 may be configured with a single server apparatus or a plurality of server apparatuses capable of communicating with each other. The driving control apparatus 100 may be realized as a cloud server. The driving control apparatus 100 may be mounted in the vehicle 300. The driving control apparatus 100 may not be mounted in the vehicle 300. At least a part of the components of the driving control apparatus 100 may be mounted in the vehicle 300. At least a part of the components of the driving control apparatus 100 may not be mounted in the vehicle 300.

### <Object Recognition Apparatus 16>

The object recognition apparatus 16 acquires data for detecting objects around the vehicle 300 from the camera 10, radar 12, and a finder 14, which will be described later, and recognizes a person present around the vehicle 300.

The object recognition apparatus 16 may be configured with one or more processors or dedicated circuits to realize the functions of each component. The processors or dedicated circuits may be configured similarly to the processors or dedicated circuits of the driving control apparatus 100. The object recognition apparatus 16 may include a memory. The memory may be configured similarly to the memory of the driving control apparatus 100. The object recognition apparatus 16 may be configured with an interface that communicates information, data, or the like with other components of the vehicle control system 1 or external apparatuses. The interface may be configured similarly to the interface of the driving control apparatus 100. The object recognition apparatus 16 may be configured as a part of the driving control apparatus 100.

The object recognition apparatus 16 may be configured with a single server apparatus s or a plurality of server apparatuses capable of communicating with each other. The object recognition apparatus 16 may be realized as a cloud server. The object recognition apparatus 16 may be mounted in the vehicle 300. The object recognition apparatus 16 may not be mounted in the vehicle 300. At least a part of the components of the object recognition apparatus 16 may be mounted in the vehicle 300. At least a part of the components of the object recognition apparatus 16 may not be mounted in the vehicle 300.

### <Vehicle 300>

The vehicle control system 1 may further include various components that the vehicle 300 is equipped with. The vehicle 300 is equipped with the camera 10. The vehicle 300 may be equipped with the radar 12, the finder 14, a communication apparatus 20, a human machine interface (HMI) 30, vehicle sensors 40, the in-vehicle camera 50, the biological information detection sensor 60, drive operation members 80, a travel control apparatus 230, and a boarding/alighting control apparatus 70, although being mandatory.

The camera 10 captures images around the vehicle 300. The range captured by the camera 10 is also referred to as an imaging range 10A (see FIG. 1). The camera 10 may be a bird's-eye view camera with a wide angle, such as a bird's-eye view camera. The radar 12 and the finder 14 may detect an object around the vehicle 300 in forms other than images, such as point cloud data. Information around the vehicle 300 detected by the camera 10, the radar 12, and the finder 14 is output to the object recognition apparatus 16.

The communication apparatus 20 communicably connects a remote center 2, which monitors the state of the vehicle 300, and the driving control apparatus 100. The HMI 30 functions as an interface between the driver or the like of the vehicle 300 and the driving control apparatus 100.

The vehicle sensors 40 detect various states of the vehicle 300 and output the detection results to the driving control apparatus 100. The vehicle sensors 40 may be controlled by the driving control apparatus 100.

The in-vehicle camera 50 captures images of the interior of the vehicle 300. The in-vehicle camera 50 may image the driver or passengers of the vehicle 300. The in-vehicle camera 50 outputs the captured images to the driving control apparatus 100. The in-vehicle camera 50 may be controlled by the driving control apparatus 100.

The biological information detection sensor 60 detects biological information on the driver or the like of the vehicle 300. The biological information may include, for example, heart rate or blood pressure. The biological information may include the alertness state of the driver of the vehicle 300.

The drive operation members 80 include an acceleration pedal 82, a brake pedal 84, and a steering wheel 86. The drive operation members 80 are operated by the driver or the like of the vehicle 300. The vehicle 300 may not be equipped with the drive operation members 80 when controlled by automated driving.

The travel control apparatus 230 includes a travel power output apparatus 200, a brake apparatus 210, and a steering apparatus 220. The travel control apparatus 230 may operate in response to operations of the drive operation members 80. The travel control apparatus 230 may operate in response to instructions from the travel controller 140 or the driving assistance controller 170 of the driving control apparatus 100.

The boarding/alighting control apparatus 70 includes the door 72 of the vehicle 300. The opening and closing of the door 72 is controlled by the door controller 190. The boarding/alighting control apparatus 70 includes a display 74 and a speaker 76, which are not essential. The display 74 is installed outside the vehicle 300 to display destination information, a departure time, or the like of the vehicle 300 for passengers outside the vehicle 300. The speaker 76 is installed outside the vehicle 300 to output the destination information, the departure time, or the like of the vehicle 300 as audio information for the passengers outside the vehicle 300.

### (Operation Example of Vehicle Control System 1)

The vehicle control system 1 according to the present embodiment detects a passenger intending to rush into the vehicle 300, and controls the opening and closing of the door 72. The driving control apparatus 100 or the object recognition apparatus 16 of the vehicle control system 1 is an apparatus used to control the opening and closing of the door 72, and is also referred to as a door control apparatus. An operation example of the vehicle control system 1 will be hereinafter described.

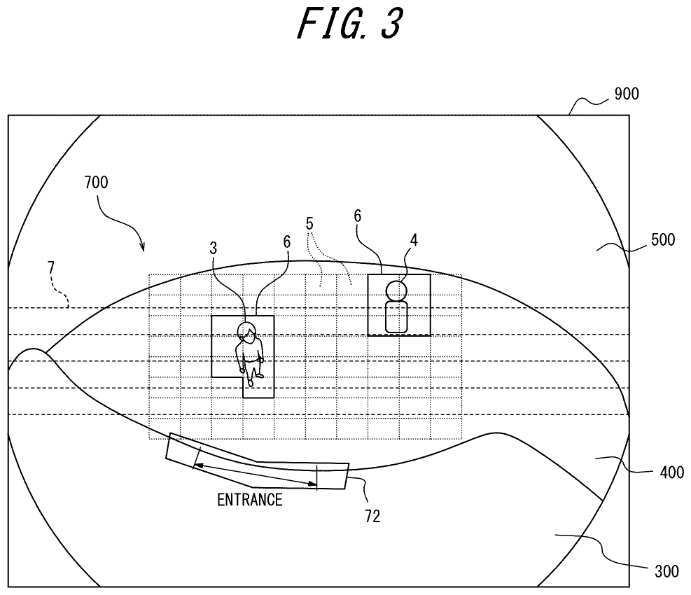

The object recognition apparatus 16 acquires a captured image 900 of the imaging range 10A from the camera 10. FIG. 3 is a diagram illustrating an example of the captured image 900 by the camera 10.

As illustrated in FIG. 3, the captured image 900 includes images of objects located within the imaging range 10A around the vehicle 300. In the example of FIG. 3, the captured image 900 includes an area occupied by the vehicle 300 (including the door 72 and an entrance (opening)) and a distant area 500, in addition to a nearby area 400 in the vicinity of the vehicle 300.

In this operation example, the camera 10 is, for example, a bird's-eye view camera with a wide angle, so the captured image 900 has distortion. For example, in the example of FIG. 3, the boundary between the area occupied by the vehicle 300 and the nearby area 400, and the boundary between the nearby area 400 and the distant area 500 have arc-shaped forms. The captured image 900 includes not only the side of the vehicle 300 but also areas near the front and rear of the vehicle 300.

The captured image 900 captures mobile objects 3 and 4 that are present around the vehicle 300. The mobile object 3 is a person who intends to board the vehicle 300. The mobile object 4 is a person who does not intend to board the vehicle 300.

The object recognition apparatus 16 acquires images captured at multiple times by the camera 10. Specifically, the camera 10 captures the imaging range 10A at both first and second times. The second time is a time that has elapsed a predetermined duration from the first time. The predetermined duration may be, for example, a frame rate when the camera 10 captures moving images. The image captured at the first time is also referred to as a first captured image. The image captured at the second time is also referred to as a second captured image.

The object recognition apparatus 16 recognizes a person such as the mobile object 3 or 4 captured in the captured image 900, and calculates the motion of the person by tracking the person. The object recognition apparatus 16 outputs, to the driving control apparatus 100, the recognition result of the person, such as the mobile object 3 or 4 captured in the captured image 900, and the calculation result of the motion.

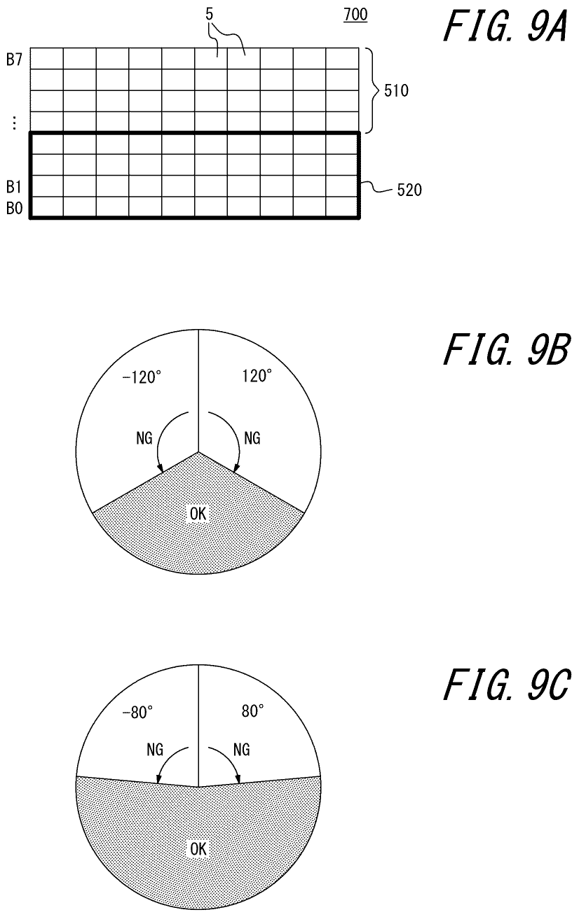

The object recognition apparatus 16 may determine whether the detected person is a pedestrian. The pedestrian refers to a person who does not intend to board the vehicle 300. The object recognition apparatus 16 may determine who is not heading for the door 72 of the vehicle 300, based on a directional range of a motion vector of the detected person's time-series trajectory, and determine the person who is not heading for the door 72 as a pedestrian. Specific examples of the directional range of the motion vector will be described later with reference to FIG. 9A to FIG. 13.

The motion vector calculator 180 of the driving control apparatus 100 calculates motion vectors, as feature values of an object, e.g., mobile object 3 or 4 captured in the captured image 900. As preparation for calculating the motion vectors, the motion vector calculator 180 divides a predetermined area 700 in the captured image 900 into multiple blocks 5. The predetermined area 700 is an area for determining whether a person is rushing into.

In this operation example, the predetermined area 700 is divided into multiple blocks 5 arranged in a grid pattern. The manner of division into the blocks 5 is not limited to this. The motion vector calculator 180 calculates a motion vector in each divided block 5.

The motion vector of the object represents the direction and distance the object has moved from the position captured in the first captured image to the position captured in the second captured image. The value obtained by dividing the distance the object has moved by the difference between the capture times (predetermined time) of the first captured image and the second captured image corresponds to the speed of the object. The motion vector calculator 180 may calculate the motion vector in each block 5 using a model, which outputs a motion vector on a block 5 basis when a first captured image and a second captured image are input. The model may be based on Dense Optical Flow or Deep Learning, for example.

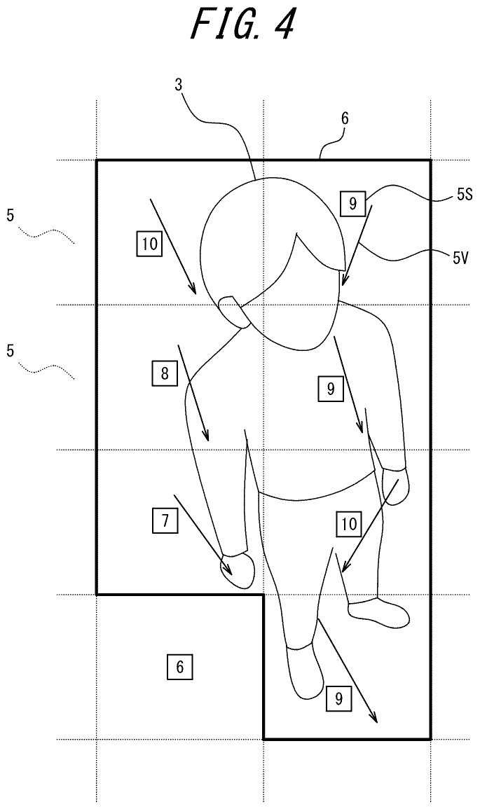

FIG. 4 is a schematic diagram explaining the determination of moving object blocks. As illustrated in FIG. 4, the motion vector calculator 180 calculates a motion vector, as a vector 5V, in each of blocks 5 in which a person as the mobile object 3 is captured. The motion vector represents the direction and distance a part of the mobile object 3 has moved.

The motion vector corrector 182 of the driving control apparatus 100 converts the motion vector of the object, e.g., mobile object 3 or 4 in each block 5, which is calculated by the motion vector calculator 180, into a scalar value of the object's motion. The scalar value of the object's motion represents the magnitude of the object's motion regardless of the direction of the object's motion. The scalar value of the object's motion is calculated as the length of the motion vector of the object, that is, the absolute value. In the example of FIG. 4, the motion vector corrector 182 calculates a scalar value 5S converted from the vector 5V, which is the motion vector of the part of the mobile object 3 in each of the blocks 5 containing the area occupied by the mobile object 3.

The motion vector corrector 182 extracts motion vectors with directions within a predetermined range, with respect to the upward direction of the captured image 900 in FIG. 3 and FIG. 4, and may convert the extracted motion vectors into scalar values of the object's motion. Specific examples of the directional range of the motion vector will be described later with reference to FIG. 9A to FIG. 13. Since the blocks 5 for which the motion vectors are converted into the scalar values are limited based on the predetermined directional range of the motion vectors, objects moving in directions other than towards the door 72 of the vehicle 300, that is, objects unrelated to the opening and closing control of the door 72 are excluded from recognition. As a result, the vehicle control system 1 can determine the intention of a person near the vehicle 300 to board with high accuracy and control the opening and closing operation of the door 72 appropriately.

The motion vector corrector 182 determines blocks 5 with converted scalar values equal to or greater than a threshold, as moving object blocks. In this operation example, the threshold for the scalar values is 7, but the threshold can be set freely. In this case, in the example of FIG. 4, the motion vector corrector 182 determines seven blocks 5 with scalar values 5S of 7 or more, as moving object blocks 6. The seven blocks 5 determined as the moving object blocks 6 are surrounded by a thick line in the example of FIG. 4. On the other hand, a block 5 with a scalar value 5S of 6 is not included in the moving object blocks 6.

The motion vector corrector 182 removes moving object blocks that are noise, among the determined moving object blocks. For example, the motion vector corrector 182 may remove, as noise, isolated moving object blocks 6, among moving object blocks 6 in the multiple blocks 5 into which the predetermined area 700 of the captured image 900 is divided. For example, even in a case in which multiple moving object blocks 6 are adjacent, the motion vector corrector 182 may remove the multiple adjacent moving object blocks 6 as noise when the size of an area connecting the adjacent moving object blocks 6 is smaller than a size expected when a person is captured.

The motion vector corrector 182 may exclude the moving object blocks 6 by setting the magnitudes of the motion vectors of the moving object blocks 6 to be removed as noise to 0.

The motion vector corrector 182 determines moving object blocks 6 corresponding to a mobile object, from the remaining moving object blocks 6 after noise removal. Specifically, the motion vector corrector 182 groups adjacent moving object blocks 6 and determines the grouped moving object blocks 6 as the moving object blocks 6 corresponding to a mobile object. In the example of FIG. 4, the seven moving object blocks 6 are grouped as moving object blocks 6 corresponding to the mobile object 3.

Here, an object located near the camera 10 and an object located far from the camera 10 are displayed in different sizes in the captured image 900, even when actual sizes are the same. Specifically, the object located far from the camera 10 is displayed smaller in the captured image 900 than the object located near the camera 10.

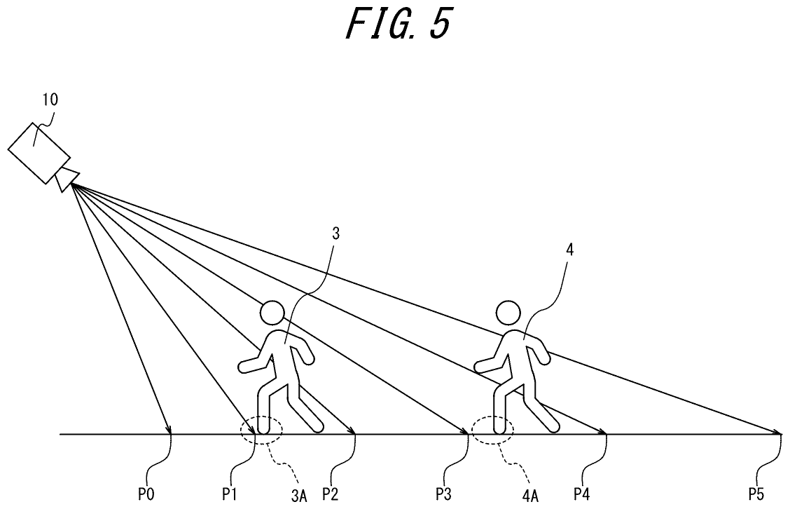

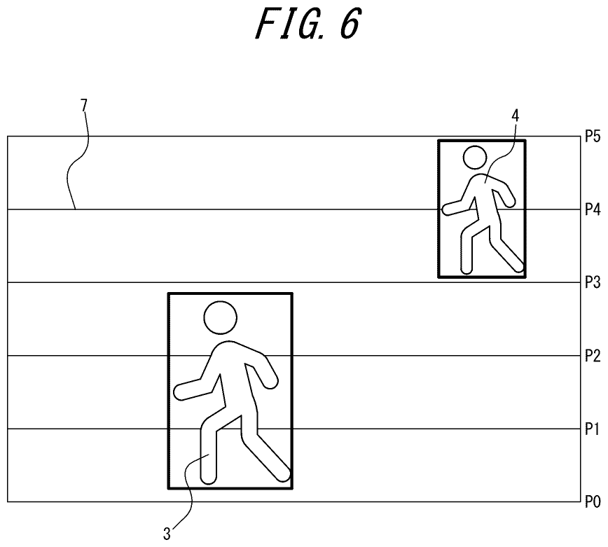

FIG. 5 is a side view illustrating an example of an imaging range in which people are present. FIG. 6 is a schematic diagram illustrating the captured image 900 corresponding to FIG. 5. As illustrated in FIG. 3, stripes 7 extending horizontally are set at equal intervals in a vertical direction in the captured image 900. As illustrated in FIG. 5, in the actual imaging range 10A, the farther from the camera 10, the wider the intervals between these stripes 7. As illustrated in FIG. 5, even when the mobile objects 3 and 4 have the same height, as illustrated in FIG. 6, the mobile object 4 located farther from the camera 10 is displayed smaller than the mobile object 3 located closer to the camera 10 in the captured image 900. The stripes 7 in FIG. 5 and FIG. 6 are associated with reference numerals P0 to P5.

As described above, the magnitude of motion of an object captured at an upper portion in the captured image 900 appears smaller than the magnitude of motion of an object at a lower portion in the captured image 900. Therefore, in order to reduce the influence of distance from the camera 10 to the object on the determination, the motion vector corrector 182 corrects the scalar values according to the position in the captured image 900.

As preparation for the correction of the scalar values, the motion vector corrector 182 determines the ground position of the mobile object. Specifically, the motion vector corrector 182 identifies a moving object block 6 located at the lowest edge of the captured image 900, for each group of the moving object blocks 6. As illustrated in FIG. 5, when viewing the imaging range 10A of the camera 10 from the side, the closest ground position 3A of the mobile object 3 to the camera 10 and the closest ground position 4A of the mobile object 4 to the camera 10 are identified. The ground position 3A corresponds to a moving object block 6 located at the lowest edge of a group of moving object blocks 6 corresponding to the mobile object 3. The ground position 4A corresponds to a moving object block 6 located at the lowest edge of a group of moving object blocks 6 corresponding to the mobile object 4.

The motion vector corrector 182 corrects the scalar values according to the ground position of the mobile object. The object recognition apparatus 16 corrects the scalar values to be larger as the ground position of the mobile object is closer to the upper edge of the captured image 900, considering that the mobile object is located farther from the camera 10 and appears smaller. The motion vector corrector 182 may correct the scalar values by multiplying the scalar values, for example, by scalar value correction coefficients listed in the correction table illustrated in Table 1.

TABLE 1

| | P0 | P1 | P2 | P3 |
|---|---|---|---|---|
| B0 | 1 | 0 | 0 | 0 |
| B1 | 1.1 | 2 | 0 | 0 |
| . . . | 1.3 | 2.2 | 3 | 0 |
| B7 | 1.5 | 2.6 | 3.4 | 4 |

In the correction table of Table 1, B0 to B7 are reference numerals corresponding to respective rows when the predetermined area 700 included in the captured image 900 is divided into eight blocks 5 in the vertical direction. B0 corresponds to an area located at the lowest edge of the predetermined area 700, and an area closest to the camera 10. B7 corresponds to an area located at the highest edge of the predetermined area 700, and an area farthest from the camera 10. P0 to P3 correspond to the stripes 7 illustrated in FIG. 3, FIG. 5, and FIG. 6.

Specifically, the motion vector corrector 182 corrects the scalar values using the correction table of Table 1 as follows. When the lowest edge of the group of moving object blocks 6 is located at the stripe represented by P0, the motion vector corrector 182 multiplies scalar values of moving object blocks 6 in the row of B0, which is at the same height as P0, among the moving object blocks 6 by 1, multiplies scalar values of moving object blocks 6 in the row of B1 by 1.1, multiplies scalar values of moving object blocks in the rows of B2 to B6 by 1.3, and multiplies scalar values of moving object blocks 6 in the row of B7 by 1.5. When the lowest edge of the group of moving object blocks 6 is located at the stripe represented by P1, the motion vector corrector 182 multiplies scalar values of moving object blocks 6 in the row of B1, which is at the same height as P1, among the moving object blocks 6 by 2, multiplies scalar values of moving object blocks in the rows of B2 to B6 by 2.2, and multiplies scalar values of moving object blocks 6 in the row of B7 by 2.6. When the lowest edge of the group of moving object blocks 6 is located at the stripe represented by P2, the motion vector corrector 182 multiplies scalar values of moving object blocks 6 in the rows of B2 to B6 among the moving object blocks 6 by 3, and multiplies scalar values of moving object blocks 6 in the row of B7 by 3.4. When the lowest edge of the group of moving object blocks 6 is located at the stripe represented by P3, the motion vector corrector 182 multiplies scalar values of moving object blocks 6 in the row of B7, which is at the same height as P3, among the moving object blocks 6 by 4.

The correction table of Table 1 mentioned above is an example. The motion vector corrector 182 may appropriately generate a correction table based on the relationship between the size and position of an object captured in the predetermined area 700 of the camera 10 and the actual size and position of the object in the imaging range 10A. The motion vector corrector 182 may adjust the correction coefficients in a column (left-right) direction according to the distortion of the captured image 900 caused by the camera 10 being a bird's-eye view camera.

The motion vector corrector 182 outputs the scalar values corrected as described above, to the door controller 190 of the driving control apparatus 100. The door controller 190 accumulates (sums), for each group of moving object blocks 6, the corrected scalar values of the moving object blocks 6 included in the group. The accumulated corrected scalar value represents the amount of movement of the object corresponding to the group of moving object blocks 6. For example, after the scalar values of the seven moving object blocks 6 corresponding to the mobile object 3 illustrated in FIG. 4 are corrected, the door controller 190 can accumulate the corrected scalar values to calculate the amount of movement of the mobile object 3.

When the amount of movement of the object is equal to or greater than a threshold, the door controller 190 determines that the object i.e. person intends to rush to board the vehicle 300. Upon determining that one or more persons captured in the captured image 900 intend to rush to board the vehicle 300, the door controller 190 detects a rush to board the vehicle 300.

Upon detecting the rush to board the vehicle 300, the door controller 190 keeps the door 72 open. The door 72 is closed when the duration of not detecting a rush to board the vehicle 300 exceeds a threshold.

When not detecting a rush to board the vehicle 300, the door controller 190 may keep the door 72 open without closing the door 72. When detecting a rush to board the vehicle 300, the door controller 190 may close the door 72.

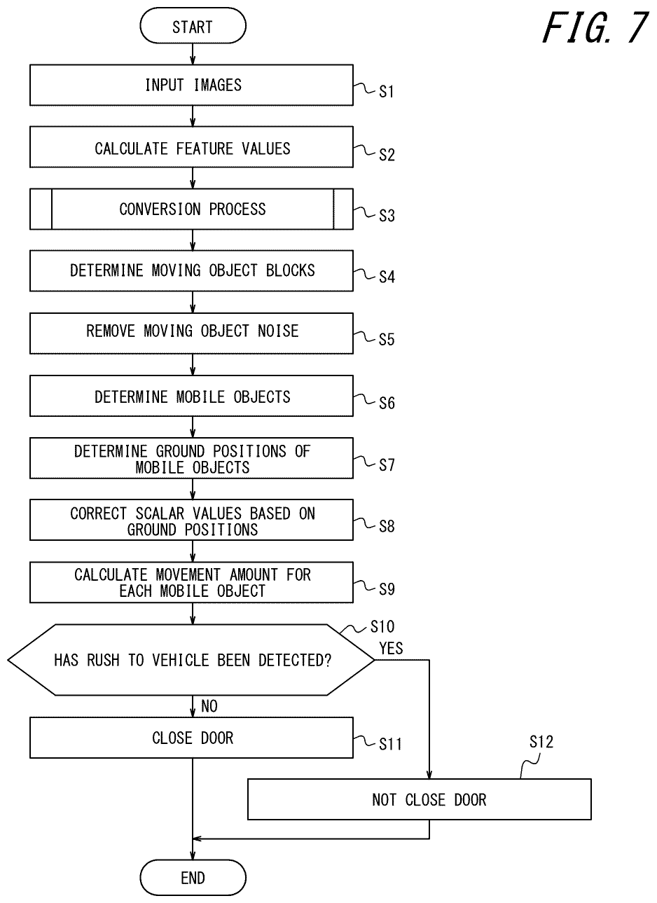

FIG. 7 is a flowchart illustrating an example procedure of a door control method according to the present disclosure. The vehicle control system 1 according to the present embodiment may execute a door control method that includes the procedure of the flowchart illustrated in FIG. 7 to determine the presence or absence of the intention of each mobile object present around the vehicle 300 to board the vehicle 300 and control the opening and closing of the door 72. The door control method may be realized as a door control program executed by a processor, such as the driving control apparatus 100 or the object recognition apparatus 16 included in the vehicle control system 1. The door control program may be stored in a non-transitory computer readable medium.

The object recognition apparatus 16 accepts, from the camera 10, input of images capturing the imaging range 10A around the vehicle 300 (S1). The object recognition apparatus 16 may accept input of information on objects around the vehicle 300 from the radar 12 or the finder 14.

The object recognition apparatus 16 calculates feature values of objects captured in a predetermined area 700 of a captured image 900 (S2). The object recognition apparatus 16 divides the predetermined area 700 into multiple blocks, and calculates, as a feature value, a motion vector of an object in each block. The object recognition apparatus 16 calculates the direction and distance of movement of the object, based on a comparison between a first captured image 900 at a first time and a second captured image 900 at a second time, which is a predetermined time after the first time. The motion vector of the object represents the direction and distance the object has moved. The value obtained by dividing the distance the object has moved by the predetermined time corresponds to the speed of the object.

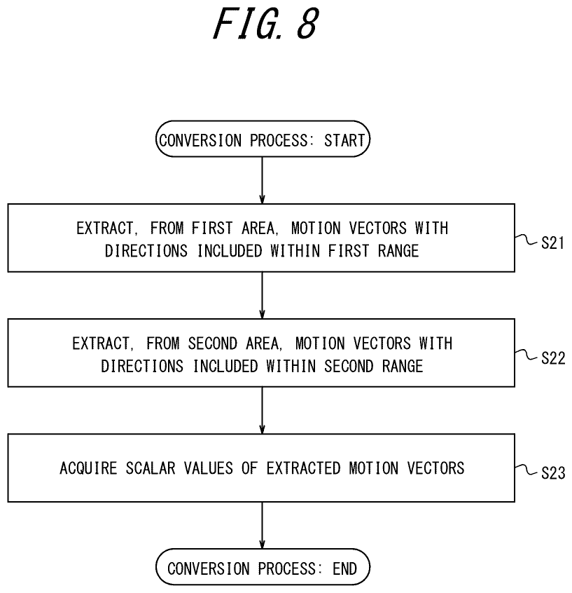

The object recognition apparatus 16 performs a conversion process to convert the motion vector of the object in each block into a scalar value of the object's motion (S3). The scalar value of the object's motion is a value that includes only the magnitude of motion, that is, the speed component of motion, without including the directional component of the object's motion. The object recognition apparatus 16 may extract motion vectors whose directions are within a predetermined range on a block-by-block basis, and convert the extracted motion vectors into scalar values of the objects' motion. The details of the conversion process will be described later with reference to FIG. 8 to FIG. 13.

The object recognition apparatus 16 determines moving object blocks (S4). The object recognition apparatus 16 determines blocks with scalar values equal to or greater than a threshold, as moving object blocks. The threshold is a value set as appropriate.

The object recognition apparatus 16 removes moving object noise (S5). The object recognition apparatus 16 may exclude, from the moving object blocks, moving object blocks that are isolated from other moving object blocks.

The object recognition apparatus 16 determines mobile objects (S6). The object recognition apparatus 16 groups adjacent moving object blocks.

The object recognition apparatus 16 determines the ground positions of the mobile objects (S7). The object recognition apparatus 16 identifies, for each group of moving object blocks, a block located at the lowest edge of the image. The object recognition apparatus 16 determines the stripe number of the block located at the identified lowest edge.

The object recognition apparatus 16 corrects the scalar values based on the ground positions (S8). The object recognition apparatus 16 retrieves, from the correction table illustrated in above Table 1 or the like, a scalar value correction coefficient for each moving object block included in each group of moving object blocks, based on the stripe number. The object recognition apparatus 16 corrects the scalar values by multiplying the scalar value by the scalar value correction coefficient for each moving object block.

The object recognition apparatus 16 calculates the amount of movement for each mobile object (S9). The object recognition apparatus 16 accumulates the corrected scalar values of the moving object blocks for each group of moving object blocks. The scalar values accumulated on a group-by-group basis represent the amount of movement of each mobile object corresponding to the group of moving object blocks.

The driving control apparatus 100 determines whether a rush by a mobile object to board the vehicle 300 has been detected (S10). The driving control apparatus 100 determines that a mobile object corresponding to a group of moving object blocks with the amount of movement equal to or greater than a threshold intends to board the vehicle 300, and detects a rush by the mobile object to board the vehicle 300. In other words, when the amount of movement is equal to or greater than the threshold in at least one group of moving object blocks, the driving control apparatus 100 determines that a rush by the mobile object to board the vehicle 300 has been detected.

When a rush by a mobile object to board the vehicle 300 has not been detected (S10: NO), the driving control apparatus 100 controls the door controller 190 to close the door 72 (S11). When a rush by a mobile object to board the vehicle 300 has been detected (S10: YES), the driving control apparatus 100 controls the door controller 190 not to close the door 72 (S12). After executing the process of S11 or S12, the vehicle control system 1 ends the execution of the procedure in the flowchart of FIG. 7.

Next, the details of the conversion process executed in step S3 of FIG. 7 are explained with reference to FIG. 8. FIG. 8 is a flowchart illustrating an example procedure of the conversion process in FIG. 7.

The object recognition apparatus 16 extracts motion vectors whose directions are included within a first range, from blocks included in a first area contained in the predetermined area 700 (S21). The object recognition apparatus 16 extracts motion vectors whose directions are included within a second range, from blocks included in a second area contained in the predetermined area 700 (S22).

FIG. 9A is a diagram illustrating an example of the predetermined area 700 divided into multiple sub-areas. FIG. 9B and FIG. 9C are diagrams illustrating an example of the ranges of motion vectors.

In FIG. 9A, an area 520 as the first area indicates a location closer to the opening than an area 510 as the second area. FIG. 9B illustrates the directional range (second range) of motion vectors to be converted into scalar values in the area 510. The example in FIG. 9B illustrates, when the directions of motion vectors are identified in a clockwise direction with respect to the upward direction of the drawing, 120 degrees to 240 degrees as the directional range of motion vectors to be converted into scalar values. FIG. 9C illustrates the directional range (first range) of motion vectors to be converted into scalar values in the area 520. The example in FIG. 9C illustrates, when the directions of motion vectors are identified in a clockwise direction with respect to the upward direction of the drawing, 80 degrees to 280 degrees as the directional range of motion vectors to be converted into scalar values.

In the example of FIG. 9A to FIG. 9C, the first area (area 520) indicates a location closer to the opening of the vehicle 300 than the second area (area 510). The first range (FIG. 9C) identifies a wider directional range than the second range (FIG. 9B). Thus, the vehicle control system 1 may convert motion vectors in the wider directional range into scalar values in the area closer to the opening. Therefore, even in a case in which the captured image 900 includes distortion due to the characteristics of the camera 10, as in the example of the captured image 900 in FIG. 3, the vehicle control system 1 can determine the intention of the mobile object to board with high accuracy.

The division of the predetermined area 700 illustrated in FIG. 9A, as well as the directional ranges of motion vectors in the respective sub-areas illustrated in FIG. 9B and FIG. 9C, is an example and can be set freely according to the characteristics of the camera 10, the behavior patterns of people, and the like.

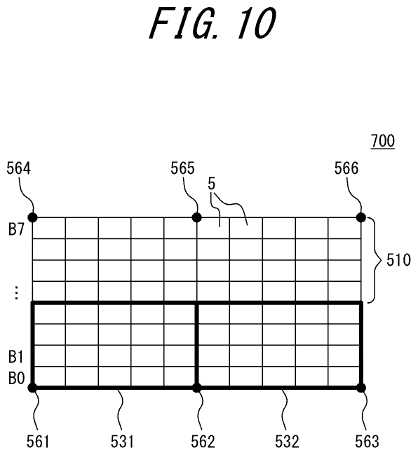

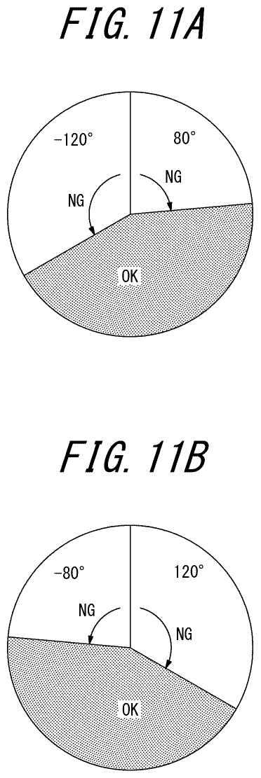

For example, FIG. 10 is a diagram illustrating an example of the predetermined area 700 divided into three sub-areas. FIG. 11A and FIG. 11B are diagrams illustrating an example of the ranges of motion vectors.

In FIG. 10, an area 531 is located farther forward of the vehicle 300 than an area 532. The area 510 is located farther away from the opening than the areas 531 and 532. FIG. 11A illustrates the directional range of motion vectors to be converted into scalar values in the area 531. The example in FIG. 11A illustrates, when the directions of motion vectors are identified in a clockwise direction with respect to the upward direction of the drawing, 80 degrees to 240 degrees as the directional range of motion vectors to be converted into scalar values. FIG. 11B illustrates the directional range of motion vectors to be converted into scalar values in the area 532. The example in FIG. 11B illustrates, when the directions of motion vectors are identified in a clockwise direction with respect to the upward direction of the drawing, 120 degrees to 280 degrees as the directional range of motion vectors to be converted into scalar values. The directional range of motion vectors to be converted into scalar values in the area 510 may also be indicated in FIG. 9B, as with FIG. 9A.

In the example of FIG. 10, FIG. 11A, and FIG. 11B, the area 531 is located farther forward of the vehicle 300 than the area 532. The directional range (FIG. 11A) in the area 531 identifies a wider directional range toward the rear of the vehicle 300 than the directional range (FIG. 11B) in the area 532. The directional range (FIG. 11B) in the area 532 identifies a wider directional range toward the front of the vehicle 300 than the directional range (FIG. 11A) in the area 531. The directional range (FIG. 9B) in the area 510, which is farther away from the opening than the areas 531 and 532, identifies a narrower range than those in the areas 531 and 532. Therefore, even when a wide imaging range is captured using an imaging apparatus with a wide angle of view as the camera 10, the vehicle control system 1 can accurately determine whether a mobile object is moving toward the opening, and can determine the intention of the mobile object to board with high accuracy.

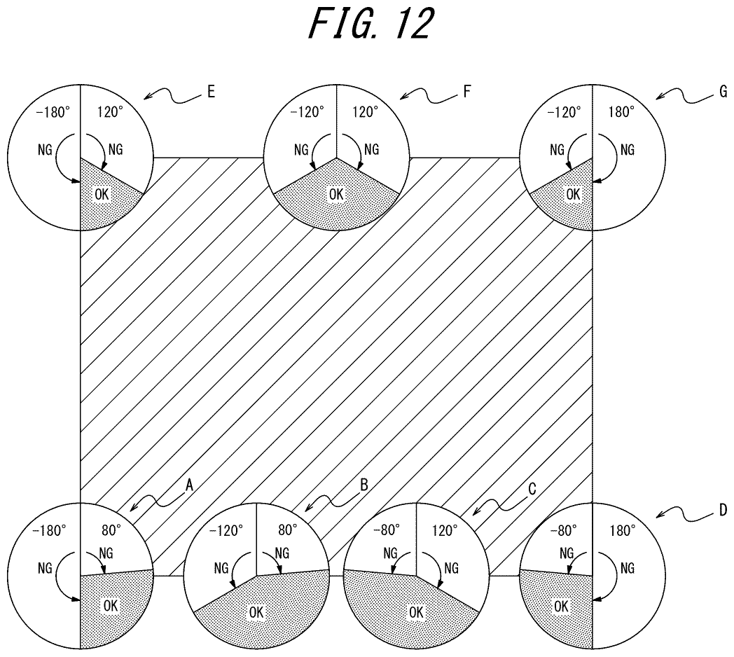

The vehicle control system 1 may specify the directional range for extracting motion vectors more finely, based on the relative position of the block 5 in the predetermined area 700. FIG. 12 is a diagram illustrating an example of the ranges of motion vectors. For example, for a block 5 included in the area 531, the extraction of a motion vector may be determined based on a directional range that is obtained by linear interpolation of directional ranges A, B, E, and F in FIG. 12 based on the relative position of that block 5 to points 561, 562, 564, and 565. For example, for a block 5 included in the area 532, the extraction of a motion vector may be determined based on a directional range that is obtained by linear interpolation of directional ranges C, D, F, and G in FIG. 12 based on the relative position of that block 5 to points 562, 563, 565, and 566. For example, for a block 5 included in the area 510, the extraction of a motion vector may be determined based on the directional range illustrated in FIG. 9B. According to such a configuration, the vehicle control system 1 can accurately determine whether a mobile object is moving toward the opening, and can determine the intention of the mobile object to board with high accuracy.

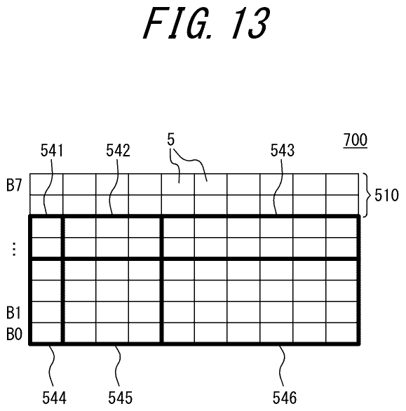

The vehicle control system 1 may specify directional ranges for extracting motion vectors by further subdividing the predetermined area 700 based on the positional relationship between the camera 10 that captures the imaging range and the opening. FIG. 13 is a diagram illustrating an example of the predetermined area 700 divided into multiple sub-areas. For example, as illustrated in FIG. 13, the predetermined area 700 may be divided into seven areas 510, 541 to 546, and a directional range for extracting motion vectors may be specified for each area. According to such a configuration, the vehicle control system 1 can determine the intention of the mobile object to board with high accuracy, based on the positional relationship between the camera 10 and the opening.

Returning to the explanation of FIG. 8. The object recognition apparatus 16 acquires the scalar values of the motion vectors extracted in S21 and S22 (S23). Specifically, the magnitude of motion (speed component) indicated by each motion vector is extracted from the motion vector. After completing the process of S23, the object recognition apparatus 16 ends the conversion process and proceeds to S4 of FIG. 7.

The present disclosure is not limited to the embodiment described above. For example, a plurality of blocks described in the block diagram may be integrated, or a single block may be divided. Instead of executing a plurality of steps described in the flowchart in chronological order in accordance with the description, the steps may be executed in parallel or in a different order according to the processing capability of the apparatus that executes each step, or as required. Other modifications can be made without departing from the spirit of the present disclosure.

Examples of some embodiments of the present disclosure are described below. However, it should be noted that the embodiments of the present disclosure are not limited to these.

[Appendix 1] A door control apparatus comprising:
a controller configured to control opening and closing of a door provided at an opening of a vehicle, based on imaging data of a predetermined imaging range of an external area relative to the opening,
wherein
the controller is configured to execute:
   a process to extract a target of motion as at least one mobile object moving toward the opening by detecting the motion from the imaging data in a time series in a predetermined area included in the imaging range; and
   a process to vary opening and closing timing of the door based on the extracted at least one mobile object,
the controller is configured to:
   in a first area contained in the predetermined area, extract the target as the mobile object when a direction of the motion is included within a predetermined first range; and
   in a second area contained in the predetermined area, extract the target as the mobile object when a direction of the motion is included within a predetermined second range.
      [Appendix 2] The door control apparatus according to appendix 1, wherein
the first area indicates an area closer to the opening than the second area, and
the first range is wider than the second range.
   [Appendix 3] The door control apparatus according to appendix 1, wherein
the first area is located farther forward of the vehicle in a longitudinal direction than the second area, and
the first range extends farther rearward in the longitudinal direction than the second range.
   [Appendix 4] The door control apparatus according to appendix 3, wherein the second range extends farther forward of the vehicle in the longitudinal direction than the first range.
   [Appendix 5] The door control apparatus according to any one of appendices 1 to 4, wherein the first and second ranges are set based on a positional relationship between an imager configured to capture the imaging range and the opening.
   [Appendix 6] The door control apparatus according to any one of appendices 1 to 5, wherein the controller is configured to:
in the imaging data in a time series, calculate a vector including a direction of motion and a magnitude of motion in each of multiple blocks into which the predetermined area is divided; and
determine blocks with vectors meeting a predetermined condition, as moving object blocks corresponding to the mobile object.
   [Appendix 7] The door control apparatus according to appendix 6, wherein the controller is configured to group adjacent blocks of the moving object blocks, and detect a group of moving object blocks as the mobile object.
   [Appendix 8] A vehicle control system comprising:
the door control apparatus according to any one of appendices 1 to 7;
the vehicle; and
an imager configured to capture the imaging range.
   [Appendix 9] A door control method for controlling opening and closing of a door provided at an opening of a vehicle, based on imaging data of a predetermined imaging range of an external area relative to the opening, the door control method comprising:
extracting, by a controller, a target of motion as at least one mobile object moving toward the opening by detecting the motion from the imaging data in a time series in a predetermined area included in the imaging range; and
varying, by the controller, opening and closing timing of the door based on the extracted at least one mobile object,
wherein the controller is configured to:
   in a first area contained in the predetermined area, extract the target as the mobile object when a direction of the motion is included within a predetermined first range; and
   in a second area contained in the predetermined area, extract the target as the mobile object when a direction of the motion is included within a predetermined second range.
      [Appendix 10] The door control method according to appendix 9, wherein
the first area indicates an area closer to the opening than the second area, and
the first range is wider than the second range.
   [Appendix 11] The door control method according to appendix 9, wherein
the first area is located farther forward of the vehicle in a longitudinal direction than the second area, and
the first range extends farther rearward in the longitudinal direction than the second range.
   [Appendix 12] The door control method according to appendix 11, wherein the second range extends farther forward of the vehicle in the longitudinal direction than the first range.
   [Appendix 13] The door control method according to any one of appendices 9 to 12, wherein the first and second ranges are set based on a positional relationship between an imager configured to capture the imaging range and the opening.
   [Appendix 14] The door control method according to any one of appendices 9 to 13, wherein the controller is configured to:
in the imaging data in a time series, calculate a vector including a direction of motion and a magnitude of motion in each of multiple blocks into which the predetermined area is divided; and
determine blocks with vectors meeting a predetermined condition, as moving object blocks corresponding to the mobile object.
   [Appendix 15] A door control program configured to control opening and closing of a door provided at an opening of a vehicle, based on imaging data of a predetermined imaging range of an external area relative to the opening, the door control program configured to cause a processor to execute operations, the operations comprising:
extracting a target of motion as at least one mobile object moving toward the opening by detecting the motion from the imaging data in a time series in a predetermined area included in the imaging range; and
varying opening and closing timing of the door based on the extracted at least one mobile object,
wherein
in a first area contained in the predetermined area, the target is extracted as the mobile object when a direction of the motion is included within a predetermined first range, and
in a second area contained in the predetermined area, the target is extracted as the mobile object when a direction of the motion is included within a predetermined second range.
   [Appendix 16] The door control program according to appendix 15, wherein
the first area indicates an area closer to the opening than the second area, and
the first range is wider than the second range.
   [Appendix 17] The door control program according to appendix 15, wherein
the first area is located farther forward of the vehicle in a longitudinal direction than the second area, and
the first range extends farther rearward in the longitudinal direction than the second range.
   [Appendix 18] The door control program according to appendix 17, wherein the second range extends farther forward of the vehicle in the longitudinal direction than the first range.
   [Appendix 19] The door control program according to any one of appendices 15 to 18, wherein the first and second ranges are set based on a positional relationship between an imager configured to capture the imaging range and the opening.
   [Appendix 20] The door control program according to any one of appendices 15 to 19, wherein the operations comprise:
in the imaging data in a time series, calculating a vector including a direction of motion and a magnitude of motion in each of multiple blocks into which the predetermined area is divided; and
determining blocks with vectors meeting a predetermined condition, as moving object blocks corresponding to the mobile object.

1. A door control apparatus comprising:
a controller configured to control opening and closing of a door provided at an opening of a vehicle, based on imaging data of a predetermined imaging range of an external area relative to the opening,
wherein
the controller is configured to execute:
a process to extract a target of motion as at least one mobile object moving toward the opening by detecting the motion from the imaging data in a time series in a predetermined area included in the imaging range; and
a process to vary opening and closing timing of the door based on the extracted at least one mobile object,
the controller is configured to:
in a first area contained in the predetermined area, extract the target as the mobile object when a direction of the motion is included within a predetermined first range; and
in a second area contained in the predetermined area, extract the target as the mobile object when a direction of the motion is included within a predetermined second range.

2. The door control apparatus according to claim 1, wherein
the first area indicates an area closer to the opening than the second area, and
the first range is wider than the second range.

3. The door control apparatus according to claim 1, wherein
the first area is located farther forward of the vehicle in a longitudinal direction than the second area, and
the first range extends farther rearward in the longitudinal direction than the second range.

4. The door control apparatus according to claim 3, wherein the second range extends farther forward of the vehicle in the longitudinal direction than the first range.

5. The door control apparatus according to claim 1, wherein the first and second ranges are set based on a positional relationship between an imager configured to capture the imaging range and the opening.

6. The door control apparatus according to claim 1, wherein the controller is configured to:
in the imaging data in a time series, calculate a vector including a direction of motion and a magnitude of motion in each of multiple blocks into which the predetermined area is divided; and
determine blocks with vectors meeting a predetermined condition, as moving object blocks corresponding to the mobile object.

7. The door control apparatus according to claim 6, wherein the controller is configured to group adjacent blocks of the moving object blocks, and detect a group of moving object blocks as the mobile object.

8. A vehicle control system comprising:
the door control apparatus according to claim 1;
the vehicle; and
an imager configured to capture the imaging range.

9. A door control method for controlling opening and closing of a door provided at an opening of a vehicle, based on imaging data of a predetermined imaging range of an external area relative to the opening, the door control method comprising:
extracting, by a controller, a target of motion as at least one mobile object moving toward the opening by detecting the motion from the imaging data in a time series in a predetermined area included in the imaging range; and
varying, by the controller, opening and closing timing of the door based on the extracted at least one mobile object,
wherein the controller is configured to:
in a first area contained in the predetermined area, extract the target as the mobile object when a direction of the motion is included within a predetermined first range; and
in a second area contained in the predetermined area, extract the target as the mobile object when a direction of the motion is included within a predetermined second range.

10. The door control method according to claim 9, wherein
the first area indicates an area closer to the opening than the second area, and
the first range is wider than the second range.

11. The door control method according to claim 9, wherein
the first area is located farther forward of the vehicle in a longitudinal direction than the second area, and
the first range extends farther rearward in the longitudinal direction than the second range.

12. The door control method according to claim 11, wherein the second range extends farther forward of the vehicle in the longitudinal direction than the first range.

13. The door control method according to claim 9, wherein the first and second ranges are set based on a positional relationship between an imager configured to capture the imaging range and the opening.

14. The door control method according to claim 9, wherein the controller is configured to:
in the imaging data in a time series, calculate a vector including a direction of motion and a magnitude of motion in each of multiple blocks into which the predetermined area is divided; and
determine blocks with vectors meeting a predetermined condition, as moving object blocks corresponding to the mobile object.

15. A non-transitory computer readable medium storing a door control program configured to control opening and closing of a door provided at an opening of a vehicle, based on imaging data of a predetermined imaging range of an external area relative to the opening, the door control program configured to cause a processor to execute operations, the operations comprising:
extracting a target of motion as at least one mobile object moving toward the opening by detecting the motion from the imaging data in a time series in a predetermined area included in the imaging range; and
varying opening and closing timing of the door based on the extracted at least one mobile object,
wherein
in a first area contained in the predetermined area, the target is extracted as the mobile object when a direction of the motion is included within a predetermined first range, and
in a second area contained in the predetermined area, the target is extracted as the mobile object when a direction of the motion is included within a predetermined second range.

16. The non-transitory computer readable medium according to claim 15, wherein
the first area indicates an area closer to the opening than the second area, and
the first range is wider than the second range.

17. The non-transitory computer readable medium according to claim 15, wherein
the first area is located farther forward of the vehicle in a longitudinal direction than the second area, and
the first range extends farther rearward in the longitudinal direction than the second range.

18. The non-transitory computer readable medium according to claim 17, wherein the second range extends farther forward of the vehicle in the longitudinal direction than the first range.

19. The non-transitory computer readable medium according to claim 15, wherein the first and second ranges are set based on a positional relationship between an imager configured to capture the imaging range and the opening.

20. The non-transitory computer readable medium according to claim 15, wherein the operations comprise:
in the imaging data in a time series, calculating a vector including a direction of motion and a magnitude of motion in each of multiple blocks into which the predetermined area is divided; and
determining blocks with vectors meeting a predetermined condition, as moving object blocks corresponding to the mobile object.
